(19) United States
(12) Patent Application Publication
(10) Pub. No.: US 2024/0080817 A1
(43) Pub. Date: Mar. 7, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Chuanfeng HE, Dongguan (CN); Shengjiang CUI, Dongguan (CN)

(21) Appl. No.: 18/498,426

(22) Filed: Oct. 31, 2023

Related U.S. Application Data
(63) Continuation of application No. PCT/CN2021/093172, filed on May 11, 2021.

(51) Int. Cl. H04W 72/0446; H04L 25/02; H04W 72/232

(52) U.S. Cl. CPC H04W 72/0446; H04L 25/0204; H04W 72/232

(57) ABSTRACT

A wireless communication method, a terminal device, and a network device are provided. The method includes the following. A terminal device receives first indication information, where the first indication information is indicative of whether at least one target slot is used for uplink transmission of a target channel or is indicative of whether the at least one target slot is used for joint channel estimation for the uplink transmission. The terminal device performs the uplink transmission according to the first indication information.

### CROSS-REFERENCE TO RELATED APPLICATION(S)

This application is a continuation of International Application No. PCT/CN2021/093172, filed May 11, 2021, the entire disclosure of which is hereby incorporated by reference.

### TECHNICAL FIELD

Embodiments of the disclosure relate to the field of communication, and more particularly to a wireless communication method, a terminal device, and a network device.

### BACKGROUND

In a new radio (NR) system, various slot (also referred to as “time slot”) structures are defined, for example, an uplink slot, a downlink slot, and a flexible slot. Symbols in the uplink slot are all uplink symbols, and therefore, the uplink slot is also referred to as a full-uplink slot. Symbols in the downlink slot are all downlink symbols, and therefore, the downlink slot is also referred to as a full-downlink slot. The flexible slot has at least one flexible symbol.

At present, a network device can indicate a slot format via higher-layer signaling (namely, a higher-layer parameter), and a terminal device can determine a location of an uplink slot, a location of a downlink slot, and a location of a flexible slot according to the slot format. Currently, the terminal device can perform uplink repetitions only in an uplink slot, and as a result, a flexible slot cannot be used for uplink repetitions, which leads to low utilization of uplink transmission resources. Similarly, such a problem may also exist in other uplink transmissions. In addition, an uplink slot is a slot used for uplink data transmission; however, with regard to a certain channel, whether an uplink slot can be used for data transmission is also a technical problem to be solved in the disclosure.

### SUMMARY

In a first aspect, a wireless communication method is provided. The method includes the following. A terminal device receives first indication information, where the first indication information is indicative of whether at least one target slot is used for uplink transmission of a target channel or is indicative of whether the at least one target slot is used for joint channel estimation for the uplink transmission. The terminal device performs the uplink transmission according to the first indication information.

In a second aspect, a wireless communication method is provided. The method includes the following. A network device sends first indication information, where the first indication information is indicative of whether at least one target slot is used for uplink transmission of a target channel or is indicative of whether the at least one target slot is used for joint channel estimation for the uplink transmission.

In a third aspect, a terminal device is provided. The terminal device includes a transceiver, a processor, and a memory. The memory is configured to store computer programs. The processor is configured to invoke and execute the computer programs stored in the memory, to perform the method described in the first aspect or in various embodiments of the first aspect.

In a fourth aspect, a network device is provided. The network device includes a transceiver, a processor, and a memory. The memory is configured to store computer programs. The processor is configured to invoke and execute the computer programs stored in the memory, to perform the method described in the second aspect or in various embodiments of the second aspect.

### BRIEF DESCRIPTION OF THE DRAWINGS

FIG. 1 is a schematic architectural diagram of a communication system provided in embodiments of the disclosure.

FIG. 2A to FIG. 2D each are a schematic diagram illustrating a flexible slot.

FIG. 3 is a schematic diagram illustrating slot distribution corresponding to uplink repetitions.

FIG. 4 is an interaction flowchart illustrating a contention-based four-step random access procedure.

FIG. 5 is a schematic diagram illustrating multi-slot transmission of a transport block (TB).

FIG. 6 is a schematic diagram illustrating joint channel estimation.

FIG. 7 is an interaction flowchart of a wireless communication method provided in embodiments of the disclosure.

FIG. 8 is a schematic diagram illustrating physical uplink shared channel (PUSCH) uplink repetitions provided in embodiments of the disclosure.

FIG. 9 is an interaction flowchart of another wireless communication method provided in embodiments of the disclosure.

FIG. 10 is a schematic block diagram of a terminal device 1000 according to embodiments of the disclosure.

FIG. 11 is a schematic block diagram of a network device 1100 according to embodiments of the disclosure.

FIG. 12 is a schematic structural diagram of a communication device 1200 provided in embodiments of the disclosure.

FIG. 13 is a schematic structural diagram of an apparatus provided in embodiments of the disclosure.

FIG. 14 is a schematic block diagram of a communication system 1400 provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

Embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), a next-generation communication systems, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), or vehicle to vehicle (V2V) communication, etc. Embodiments of the disclosure can also be applied to these communication systems.

Optionally, a communication system in embodiments of the disclosure may be applied to a carrier aggregation (CA) scenario, a dual connectivity (DC) scenario, or a standalone (SA) network deployment scenario.

There is no limitation on the spectrum adopted in embodiments of the disclosure. For example, embodiments of the disclosure is applicable to a licensed spectrum, or is applicable to an unlicensed spectrum.

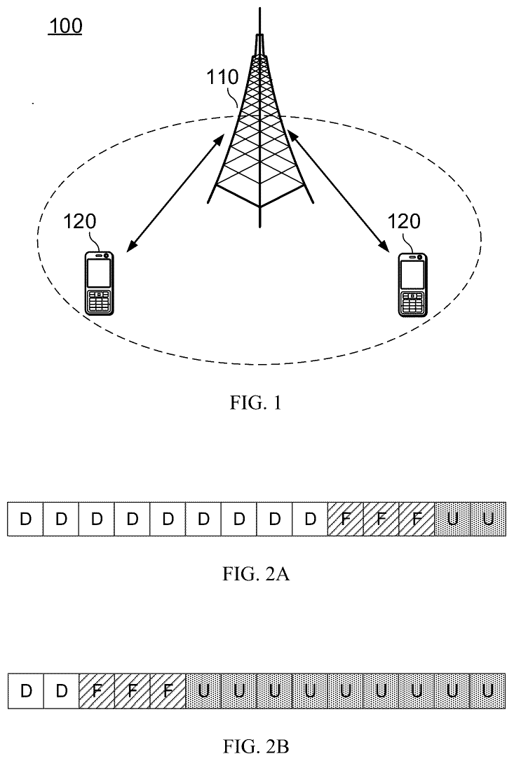

Exemplarily, FIG. 1 illustrates a communication system 100 to which embodiments of the disclosure are applied. The communication system 100 may include a network device 110. The network device 110 may be a device for communicating with a terminal device 120 (also referred to as “communication terminal” or “terminal”). The network device 110 can provide a communication coverage for a specific geographical area and communicate with terminal devices in the coverage area.

FIG. 1 exemplarily illustrates one network device and two terminal devices. Optionally, the communication system 100 may also include multiple network devices, and there can be other quantities of terminal devices in a coverage area of each of the network devices. Embodiments of the disclosure are not limited in this regard.

Optionally, the communication system 100 may further include other network entities such as a network controller, a mobile management entity, or the like, and embodiments of the disclosure are not limited in this regard.

It should be understood that, in embodiments of the disclosure, a device with communication functions in a network/system can be referred to as a “communication device”. Taking the communication system 100 illustrated in FIG. 1 as an example, the communication device may include the network device 110 and the terminal device(s) 120 that have communication functions. The network device 110 and the terminal device(s) 120 can be the devices described above and will not be elaborated again herein. The communication device may further include other devices such as a network controller, a mobile management entity, or other network entities in the communication system 100, and embodiments of the disclosure are not limited in this regard.

It should be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

Various embodiments of the disclosure are described in connection with a terminal device and a network device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc. The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

The network device may be a device for communicating with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or may be a relay station or an AP, or an in-vehicle device, a wearable device, a network device (gNB) in an NR network, or a network device in a future evolved PLMN, etc.

In embodiments of the disclosure, the network device provides services for a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

Before introducing the technical solutions of the disclosure, the related art of the disclosure will be elaborated below.

I. Slot Structure in NR System

In an NR system, a flexible (F) symbol is introduced, and the flexible symbol has the following characteristics.
1. The flexible symbol refers to a symbol of which the direction is undefined, and can be modified into a downlink symbol or an uplink symbol via other signaling;
2. The flexible symbol may also refer to a symbol reserved for future use for the sake of forward compatibility.
3. The flexible symbol is used for transmit/receive transition of a terminal, and is similar to a guard period (GP) symbol in an LTE time division duplex (TDD) system. The terminal completes transmit/receive transition within the symbol.

As described above, in an NR system, various slot structures are defined, such as an uplink slot, a downlink slot, and a flexible slot. Symbols in the uplink slot are all uplink (U) symbols. Symbols in the downlink slot are all downlink (D) symbols. A flexible slot has at least one flexible symbol, that is, if a slot has at least one flexible symbol, the slot is referred to as a flexible slot. Each slot structure corresponds to one index.

It should be understood that, the slot structure is also referred to as a slot format, and the disclosure is not limited in this regard.

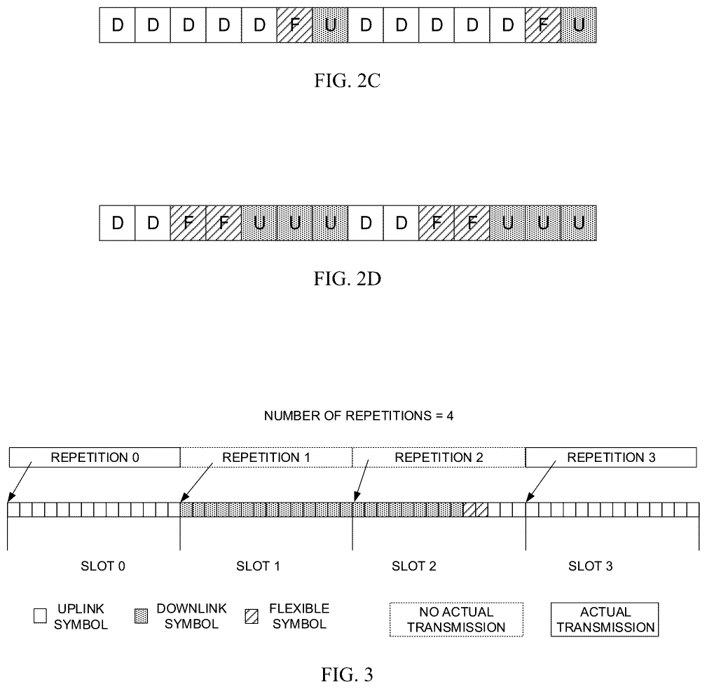

FIG. 2A to FIG. 2D each are a schematic diagram illustrating a flexible slot. The flexible slot illustrated in each of FIG. 2A to FIG. 2D has a flexible symbol(s).

II. Physical Uplink Shared Channel (PUSCH) Repetitions and Physical Uplink Control Channel (PUCCH) Repetitions in NR

In an NR system, in order to support an ultra-reliable and low-latency communication (URLLC) service, repetitions of uplink data transmission are adopted to improve reliability of transmission. It should be understood that, “PUSCH repetitions”, “repetitions of uplink data transmission”, and “uplink repetitions” are equivalent to each other, and the disclosure is not limited in this regard.

A network device may schedule uplink repetitions via downlink control information (DCI). The DCI may contain the number (that is, quantity) K of uplink repetitions. The number K of uplink repetitions may be the number of nominal repetitions, i. e. the number of repetitions indicated by the network device, but the number of actual repetitions may be less than or equal to the number K of uplink repetitions. Alternatively, the number K of uplink repetitions may be the number of actual repetitions.

At present, the network device can indicate a slot format via a higher-layer parameter TDD-UL-DL-ConfigurationCommon or TDD-UL-DL-ConfigDedicated. A terminal device can determine, according to the slot format, which symbols in a slot are uplink symbols, which symbols in the slot are downlink symbols, and which symbols in the slot are flexible symbols, that is, the terminal device can determine a location of an uplink slot, a location of a downlink slot, and a location of a flexible slot according to the slot format. Currently, the terminal device can perform uplink repetitions only in an uplink slot, and as a result, a flexible slot cannot be used for uplink repetitions, which leads to low utilization of uplink transmission resources.

On one hand, based on determining the slot format according to the higher-layer parameter, the network device may dynamically indicate the slot format via DCI, that is, modify at least one flexible symbol into an uplink symbol or a downlink symbol via DCI. If all the flexible symbols are modified into uplink symbols or downlink symbols via DCI, there will be no flexible slot. However, if the DCI is lost, since the terminal device has not received the DCI, the terminal device still determines, according to the slot format indicated by the higher-layer parameter, that only the slot(s) indicated as uplink by the higher-layer parameter can be used for uplink repetitions, while the network device considers that all uplink slots can be used for uplink repetitions after modification, which will lead to inconsistent understanding between the network device and the terminal device regarding the slot used for uplink repetitions. If only some of the flexible symbols are modified into uplink symbols or downlink symbols via DCI, the flexible slot may still exist. On one hand, if the DCI is lost, since the terminal device has not received the DCI, the terminal device still determines, according to the slot format indicated by the higher-layer parameter, that only the slot(s) indicated as uplink by the higher-layer parameter can be used for uplink repetitions, while the network device considers that all uplink slots can be used for uplink repetitions after modification, which will lead to inconsistent understanding between the network device and the terminal device regarding the slot used for uplink repetitions. On the other hand, since the flexible slot may still exist but the terminal device can perform uplink repetitions only in an uplink slot, the flexible slot cannot be used for uplink repetitions, which results in low utilization of uplink transmission resources.

For example, FIG. 3 is a schematic diagram illustrating slot distribution corresponding to uplink repetitions. As illustrated in FIG. 3, assume that according to the slot format semi-statically indicated by the higher-layer parameter or according to the slot format dynamically indicated by the DCI, the terminal device determines that symbols in slot 1 are all downlink symbols (i. e. slot 1 is a downlink slot and therefore cannot be used for uplink repetitions), and slot 2 has a flexible symbol(s) (i. e. slot 2 is a flexible slot and therefore cannot be used for uplink repetitions); and then the terminal device will perform uplink repetitions in slot 0 and slot 3.

On the other hand, as stated above, an uplink slot is a slot used for uplink data transmission. However, with regard to a certain channel, whether an uplink slot can be used for data transmission is also a technical problem to be solved in the disclosure.

It should be understood that, in order to improve coverage performance of PUCCH transmission, PUCCH repetitions are also adopted in a 3rd-generation partnership project (3GPP) release 17 (R17) standard.

III. Interaction Flowchart Illustrating Contention-Based Four-Step Random Access Procedure.

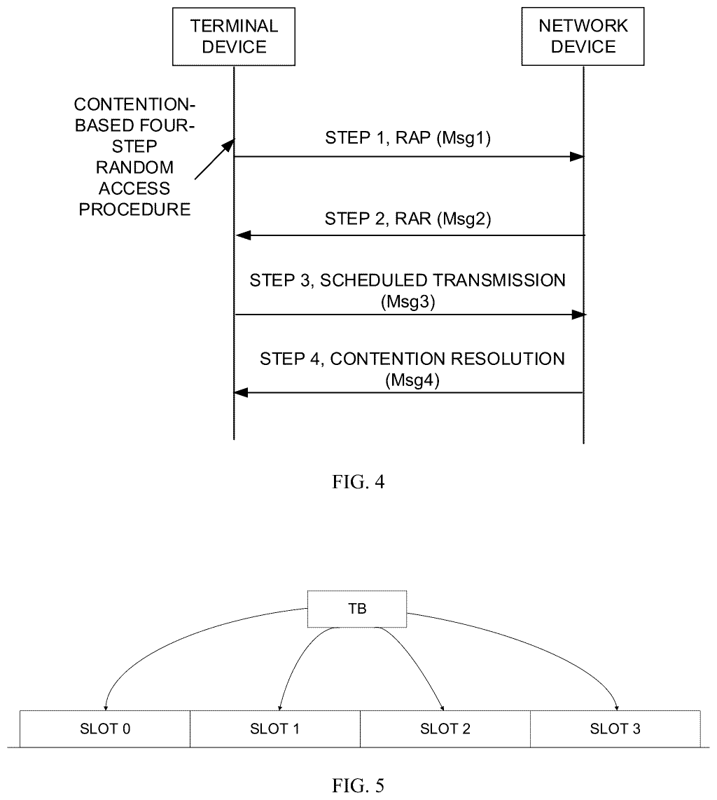

FIG. 4 is an interaction flowchart illustrating a contention-based four-step random access procedure.

As illustrated in FIG. 4, the random access procedure may include the following four steps.

Step 1, Message 1 (Msg1).

A terminal device transmits the Msg1 to a network device, so as to inform to the network device that a random access request is initiated by the terminal device. The Msg1 carries a random access preamble (RAP) (or referred to as a RAP sequence, a preamble sequence, a preamble, etc.). In addition, the Msg1 can also be used for the network device to estimate a transmission delay between the network device and the terminal device and perform uplink time alignment accordingly.

Specifically, the terminal device selects a preamble index and a physical random access channel (PRACH) resource used for transmitting the preamble, and then transmits the preamble on the PRACH. The network device may notify, by broadcasting a system information block (SIB) such as SIB1, to all terminal devices which time-frequency resource(s) can be used for transmitting the preamble.

Step 2, Message 2 (Msg2).

After receiving the Msg1 transmitted by the terminal device, the network device transmits the Msg2 (that is, a random access response (RAR) message) to the terminal device. The Msg2 may carry, for example, a timing advance (TA), an uplink grant (for example, uplink resource configuration), and a temporary cell-radio network temporary identity (TC-RNTI), etc.

The terminal device monitors a physical downlink control channel (PDCCH) in an RAR window, so as to receive the RAR message replied by the network device. The RAR message may be descrambled by a corresponding random access radio network temporary identity (RA-RNTI).

If the RAR message replied by the network device is not received by the terminal device within the RAR window, it is considered that the random access procedure failed.

If the terminal device receives an RAR message successfully, and a preamble index carried in the RAR message is the same as a preamble index transmitted by the terminal device via the Msg1, it is considered that the RAR message is successfully received. In this case, the terminal device can stop monitoring in the RAR window.

The Msg2 may include RAR messages for multiple terminal devices, and an RAR message for each terminal device may contain an RAP identity (RAPID) used by the terminal device, information of a resource used for message 3 (Msg3) transmission, TA adjustment information, a TC-RNTI, etc.

Step 3, Msg3.

After receiving the RAR message, the terminal device determines whether the RAR message is an RAR message for the terminal device. For example, the terminal device may check based on an RAPID. After determining that the RAR message is the RAR message for the terminal device, the terminal device generates the Msg3 at a radio resource control (RRC) layer, and transmits the Msg3 to the network device, where the Msg3 carries an ID of the terminal device, etc.

Specifically, for different random-access trigger events, the Msg3 in step 3 of the four-step random access procedure may contain different contents in order for scheduled transmission.

For example, for an initial access scenario, the Msg3 may contain an RRC connection request generated at the RRC layer. The Msg3 at least carries a non-access stratum (NAS) ID for the terminal device, and may further carry, for example, a serving-temporary mobile subscriber identity (S-TMSI) for the terminal device or a random number.

For another example, for a connection re-establishment scenario, the Msg3 may contain an RRC connection re-establishment request generated at the RRC layer and does not carry any NAS message. In addition, the Msg3 may further carry, for example, a C-RNTI, protocol control information (PCI), etc.

For another example, for a handover scenario, the Msg3 may contain an RRC handover confirm message generated at the RRC layer and a C-RNTI for the terminal device. The Msg3 may further carry, for example, a buffer status report (BSR). For other trigger events such as uplink/downlink data arrival, the Msg3 at least contains the C-RNTI for the terminal device.

Step 4, Message 4 (Msg4).

The network device transmits the Msg4 to the terminal device. The terminal device correctly receives the Msg4 to complete contention resolution. For example, in an RRC connection establishment procedure, the Msg4 may carry an RRC connection establishment message.

Since the terminal device will carry a unique ID of the terminal device in the Msg3 in step 3, such as a C-RNTI or an ID (such as an S-TMSI or a random number) from a core network, in a contention resolution mechanism, the network device will carry a unique terminal-device ID in the Msg4 to indicate a terminal device that succeeds in the contention, while other terminal devices that fail in the contention resolution will initiate random access again.

It should be noted that, if the network device does not correctly receive the Msg3, the network device will indicate, via DCI, scheduling information of retransmission of the Msg3. As stated above, in order to improve coverage performance of PUSCH transmission, PUSCH repetitions are adopted in the 3GPP R17 standard, which includes Msg3 PUSCH repetitions, relating to uplink repetitions of Msg3 initial transmission and uplink repetitions of Msg3 retransmission.

IV. Multi-Slot Transmission of Transport Block (TB)

At present, in 3GPP R17, a new scheme for PUSCH transmission is to be standardized, and the main idea is to map a TB onto multiple slots so as to enhance coverage. This scheme is referred to as TB over multi-slot (TBoMS) transmission. FIG. 5 is a schematic diagram illustrating multi-slot transmission of a TB. As illustrated in FIG. 5, a TB subjected to channel coding can be mapped onto four slots for transmission. Optionally, based on this, repetitions of the TB mapped onto multiple slots may also be performed in a unit of multiple slots.

V. Joint Channel Estimation

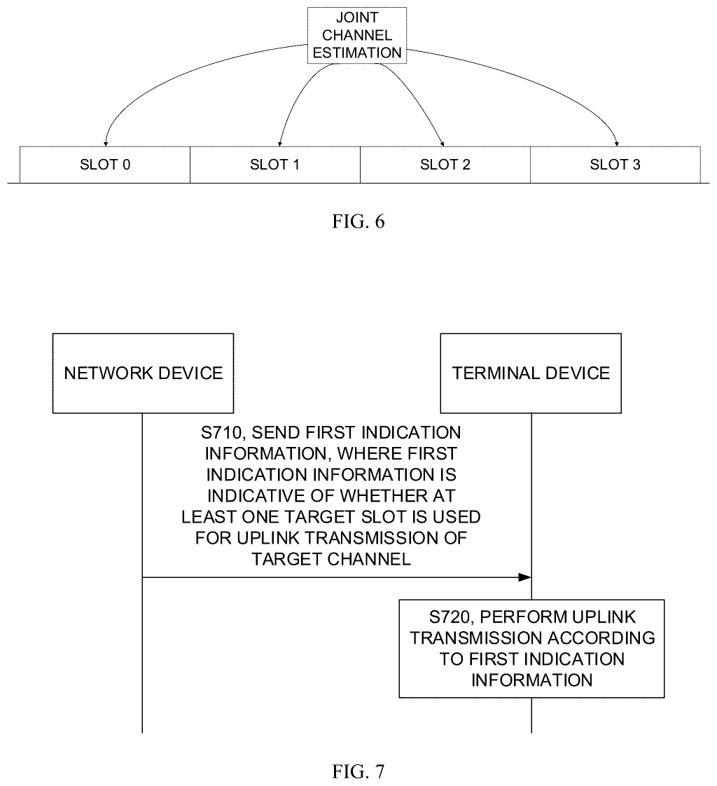

In 3GPP R17, joint channel estimation for uplink repetitions is to be standardized, i. e. a network device performs joint channel estimation based a demodulation reference signal (DMRS) over multiple slots occupied by uplink repetitions, so as to improve accuracy of channel estimation. With regard to joint channel estimation, it is necessary to determine the number of slots for joint channel estimation or the number of uplink repetitions, and in joint channel estimation of the network device, the network device will assume that the DMRS over multiple slots is relevant, including consistency in power, antenna port, and precoding, phase continuity, etc. FIG. 6 is a schematic diagram illustrating joint channel estimation. As illustrated in FIG. 6, the network device may perform joint channel estimation based on a DMRS over slot 0 to slot 3.

A wireless communication method, a terminal device, and a network device are provided. With regard to a flexible slot, whether the flexible slot is used for uplink transmission can be indicated by first indication information, which can improve resource utilization. In addition, with regard to an uplink slot, whether the uplink slot can be used for uplink transmission can also be explicitly indicated by the first indication information.

The technical solutions of the disclosure will be described in detail below.

FIG. 7 is an interaction flowchart of a wireless communication method provided in embodiments of the disclosure. As illustrated in FIG. 7, the method includes the following.

S710, a network device sends first indication information to a terminal device, where the first indication information is indicative of whether at least one target slot is used for uplink transmission of a target channel.

S720, the terminal device performs uplink transmission according to the first indication information.

Optionally, regarding the target channel and the uplink transmission, there are several possible implementations below, but the disclosure is not limited thereto.

Implementation I: The target channel is a target PUSCH, and the uplink transmission of the target channel is uplink repetitions of the target PUSCH.

Implementation II: The target channel is a target PUCCH, and the uplink transmission of the target channel is uplink repetitions of the target PUCCH.

Implementation III: The target channel is a target PUSCH, where the target PUSCH carries Msg3. Based on this, the uplink transmission of the target channel is uplink repetitions of an initial transmission carrying Msg3.

Implementation IV: The target channel is a target PUSCH, where the target PUSCH carries Msg3. Based on this, the uplink transmission of the target channel is uplink repetitions of a retransmission carrying Msg3.

Implementation V: The target channel is a target PUSCH, where the target PUSCH carries multi-slot transmission of a TB. Based on this, the uplink transmission of the target channel is the multi-slot transmission of the TB.

It should be understood that, the target PUSCH specifically refers to a certain PUSCH, and the target PUCCH specifically refers to a certain PUCCH.

Optionally, each target slot may be a flexible slot or an uplink slot, for example, the at least one target slot is all flexible slot(s), or is all uplink slot(s), or some of the at least one target slot is a flexible slot(s) and the rest of the at least one target slot is an uplink slot(s), and the disclosure is not limited in this regard.

It should be understood that, the target slot used for the uplink transmission of the target channel may be referred to as an available slot. Therefore, “the first indication information is indicative of whether the at least one target slot is used for the uplink transmission of the target channel” also means that the first indication information is indicative of whether the at least one target slot is an available slot.

Implementation I will be described below.

Optionally, with regard to uplink repetitions of the target PUSCH, the first indication information may be carried in first DCI for scheduling the uplink repetitions.

Optionally, the first DCI may contain the number of repetitions for the target PUSCH. The number of repetitions may be the number K1 of nominal repetitions or the number K2 of actual repetitions, where K1 and K2 each are an integer, K1>1, and K2>1. The number K1 of nominal repetitions refers to the number of repetitions for the target PUSCH configured for the terminal device by the network device, but the number of actual repetitions of the terminal device may be less than or equal to the number of nominal repetitions. The number K2 of actual repetitions refers to the number of actual repetitions of the terminal device for the target PUSCH.

It should be understood that, if the first DCI contains the number K1 of nominal repetitions for the target PUSCH, the K1 repetitions for the uplink repetitions correspond to K1 consecutive slots, where the K1 consecutive slots constitute a first slot set, and the at least one target slot is a slot in the first slot set. It should be noted that, the first slot set may also be any slot set configured for the terminal device by the network device. There is no limitation on how to determine the first slot set in the disclosure.

It should be understood that, if the first DCI contains the number K2 of actual repetitions for the target PUSCH, the terminal device can search for K2 available slots according to a start position for repetitions configured for the terminal device by the network device and the number K2 of actual repetitions.

It should be understood that, in order to distinguish the available slot in different implementations described above, in implementation I, the available slot may be referred to as a first slot.

Optionally, assuming that the at least one target slot is all flexible slot(s), the length of the first indication information or the number of bits occupied by the first indication information may be any one of the following, but is not limited thereto.

(1) The first indication information has a length of one bit.

It should be understood that, if the at least one target slot is one flexible slot, the first indication information indicates whether the flexible slot is used for the uplink transmission of the target channel. If the at least one target slot is multiple flexible slots, the first indication information jointly indicates (namely, simultaneously indicates) whether the flexible slots are used for the uplink transmission of the target PUSCH.

Optionally, for a flexible slot, the network device may determine, based on a symbol corresponding to the target PUSCH in the flexible slot, whether the flexible slot is used for the uplink transmission of the target PUSCH. If the network device determines that the symbol corresponding to the target PUSCH in the flexible slot is not a downlink symbol, the network device can determine that the flexible slot can be used for the uplink transmission of the target PUSCH. Otherwise, if the network device determines that the symbol corresponding to the target PUSCH in the flexible slot is a downlink symbol, the network device can determine that the flexible slot cannot be used for the uplink transmission of the target PUSCH.

It should be understood that, in the disclosure, there is no limitation on how the network device determines whether the flexible slot is used for the uplink transmission of the target PUSCH.

Optionally, assume that the at least one target slot is multiple flexible slots. When the first indication information jointly indicates whether the flexible slots are used for the uplink transmission of the target PUSCH, if at least one of the flexible slots cannot be used for the uplink transmission of the target PUSCH, the network device will indicate, via the first indication information, that the flexible slots cannot be used for the uplink transmission of the target PUSCH; otherwise, if all of the flexible slots can be used for the uplink transmission of the target PUSCH, the network device will indicate, via the first indication information, that the flexible slots can be used for the uplink transmission of the target PUSCH.

(2) The first indication information has a length of N1 bits, where the N1 bits are in one-to-one correspondence with the at least one target slot, N1 is an integer and N1>1, and each of the N1 bits is indicative of whether a corresponding target slot is used for uplink transmission.

N1 is the number (that is, quantity) of the at least one target slot.

It should be understood that, if the at least one target slot is one flexible slot, the first indication information indicates whether the flexible slot is used for the uplink transmission of the target channel. If the at least one target slot is multiple flexible slots, each bit in the first indication information indicates whether a corresponding target slot is used for uplink transmission.

Optionally, for a flexible slot, the network device may determine, based on a symbol corresponding to the target PUSCH in the flexible slot, whether the flexible slot is used for the uplink transmission of the target PUSCH. If the network device determines that the symbol corresponding to the target PUSCH in the flexible slot is not a downlink symbol, the network device can determine that the flexible slot can be used for the uplink transmission of the target PUSCH. Otherwise, if the network device determines that the symbol corresponding to the target PUSCH in the flexible slot is a downlink symbol, the network device can determine that the flexible slot cannot be used for the uplink transmission of the target PUSCH.

It should be understood that, in the disclosure, there is no limitation on how the network device determines whether the flexible slot is used for the uplink transmission of the target PUSCH.

(3) The first indication information has a length of K1 bits, where the K1 bits are in one-to-one correspondence with K1 consecutive slots, and each of the K1 bits is indicative of whether a corresponding slot in the K1 consecutive slots is used for uplink transmission.

K1 is the number of slots in the first slot set, where the first slot set may have at least one of an uplink slot or a flexible slot. Each bit in the first indication information is indicative of whether a corresponding slot in the consecutive slots is used for uplink transmission. Here, the consecutive slots each may be an uplink slot or a flexible slot. It can be understood that, if the at least one target slot is all flexible slot(s) (in this case, the uplink slot is understood as available for the uplink transmission of the target channel), for any uplink slot in the K1 consecutive slots, the terminal device will not determine, according to the first indication information, whether the uplink slot is used for uplink transmission; and for any flexible slot in the K1 consecutive slots, the terminal device needs to determine, according to the first indication information, whether the flexible slot is used for uplink transmission.

Optionally, for a flexible slot, the network device may determine, based on a symbol corresponding to the target PUSCH in the flexible slot, whether the flexible slot is used for the uplink transmission of the target PUSCH. If the network device determines that the symbol corresponding to the target PUSCH in the flexible slot is not a downlink symbol, the network device can determine that the flexible slot can be used for the uplink transmission of the target PUSCH. Otherwise, if the network device determines that the symbol corresponding to the target PUSCH in the flexible slot is a downlink symbol, the network device can determine that the flexible slot cannot be used for the uplink transmission of the target PUSCH.

It should be understood that, in the disclosure, there is no limitation on how the network device determines whether the flexible slot is used for the uplink transmission of the target PUSCH.

Optionally, assuming that the at least one target slot is all uplink slot(s) (in this case, the uplink slot is understood as not yet determined regarding whether the uplink slot can be used for the uplink transmission of the target channel), the length of the first indication information or the number of bits occupied by the first indication information may be any one of the following, but is not limited thereto.

(1) The first indication information has a length of one bit.

It should be understood that, if the at least one target slot is one uplink slot, the first indication information indicates whether the uplink slot is used for the uplink transmission of the target channel. If the at least one target slot is multiple uplink slots, the first indication information jointly indicates (namely, simultaneously indicates) whether the uplink slots are used for the uplink transmission of the target PUSCH.

It should be understood that, in the disclosure, there is no limitation on how the network device determines whether the uplink slot is used for the uplink transmission of the target PUSCH.

Optionally, assume that at least one target slot is multiple uplink slots. When the first indication information jointly indicates whether the uplink slots are used for the uplink transmission of the target PUSCH, if at least one of the uplink slots cannot used for the uplink transmission of the target PUSCH, the network device indicates, via the first indication information, that the uplink slots cannot be used for the uplink transmission of the target PUSCH; otherwise, if all of the uplink slots can be used for the uplink transmission of the target PUSCH, the network device indicates, via the first indication information, that the uplink slots can be used for the uplink transmission of the target PUSCH.

(2) The first indication information has a length of N1 bits, where the N1 bits are in one-to-one correspondence with the at least one target slot, N1 is an integer and N1>1, and each of the N1 bits is indicative of whether a corresponding target slot is used for uplink transmission.

N1 is the number of the at least one target slot.

It should be understood that, if the at least one target slot is one uplink slot, the first indication information indicates whether the uplink slot is used for the uplink transmission of the target channel. If the at least one target slot is multiple uplink slots, each bit in the first indication information indicates whether a corresponding uplink slot is used for uplink transmission.

It should be understood that, in the disclosure, there is no limitation on how the network device determines whether the uplink slot is used for the uplink transmission of the target PUSCH.

(3) The first indication information has a length of K1 bits, where the K1 bits are in one-to-one correspondence with K1 consecutive slots, and each of the K1 bits is indicative of whether a corresponding slot in the K1 consecutive slots is used for uplink transmission.

K1 is the number of slots in the first slot set.

Optionally, if the at least one target slot includes an uplink slot and a flexible slot (in this case, the uplink slot is understood as not yet determined regarding whether the uplink slot can be used for the uplink transmission of the target channel), the length of the first indication information or the number of bits occupied by the first indication information may be any one of the following, but is not limited thereto.

(1) The first indication information has a length of one bit.

It should be understood that, if the at least one target slot is one uplink slot or one flexible slot, the first indication information indicates whether the uplink slot or the flexible slot is used for the uplink transmission of the target channel. If the at least one target slot includes an uplink slot and a flexible slot, the first indication information jointly indicates (namely, simultaneously indicates) whether the slots are used for the uplink transmission of the target PUSCH.

It should be understood that, regarding how the network device determines whether the flexible slot is used for the uplink transmission of the target PUSCH, reference can be made to the above elaborations, which will not be described in detail again in the disclosure. In addition, in the disclosure, there is no limitation on how the network device determines whether the uplink slot is used for the uplink transmission of the target PUSCH.

(2) The first indication information has a length of two bits, where one of the two bits is indicative of whether an uplink slot in the at least one target slot is used for the uplink transmission of the target channel, and the other one of the two bits is indicative of whether a flexible slot in the at least one target slot is used for the uplink transmission of the target channel.

It should be understood that, regarding how the network device determines whether the flexible slot is used for the uplink transmission of the target PUSCH, reference can be made to the above elaborations, which will not be described in detail again in the disclosure. In addition, in the disclosure, there is no limitation on how the network device determines whether the uplink slot is used for the uplink transmission of the target PUSCH.

(3) The first indication information has a length of N1 bits, where the N1 bits are in one-to-one correspondence with the at least one target slot, N1 is an integer and N1>1, and each of the N1 bits is indicative of whether a corresponding target slot is used for uplink transmission.

N1 is the number of the at least one target slot.

(4) The first indication information has a length of K1 bits, where the K1 bits are in one-to-one correspondence with K1 consecutive slots, and each of the K1 bits is indicative of whether a corresponding slot in the K1 consecutive slots is used for uplink transmission.

K1 is the number of slots in the first slot set.

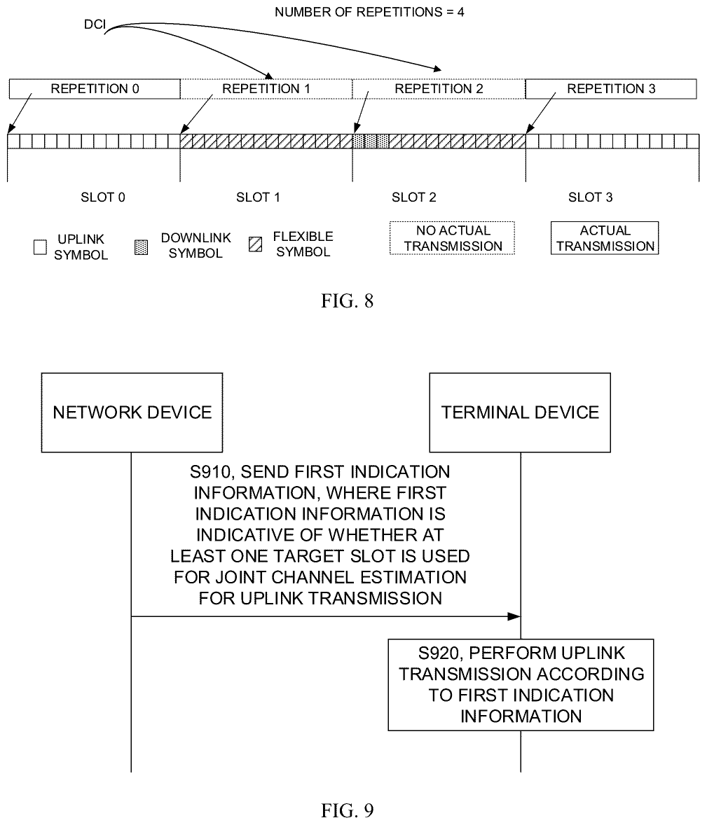

Exemplarily, FIG. 8 is a schematic diagram illustrating PUSCH uplink repetitions provided in embodiments of the disclosure. As illustrated in FIG. 8, when four PUSCH repetitions are scheduled by DCI and it is assumed that a slot set corresponding to repetitions is four consecutive slots, if the four slots include a flexible slot, it is required to indicate, via DCI, whether the flexible slot can be used for PUSCH transmission. As illustrated in FIG. 8, the terminal device may determine, according to a slot format indicated by higher-layer signaling TDD-UL-DL-ConfigurationCommon or TDD-UL-DL-ConfigDedicated, that slot 0 and slot 3 each are an uplink slot, where the uplink slot is understood as available for PUSCH repetitions, but slot 1 and slot 2 each are indicated as a flexible slot by the higher-layer signaling. The terminal device determines, according to the first indication information carried in the DCI scheduling PUSCH repetitions, whether the flexible slot is used for PUSCH repetitions. As illustrated in FIG. 8, the network device indicates, via the first indication information, that slot 1 and slot 2 are not used for PUSCH repetitions.

As can be seen, on one hand, for a flexible slot, the first indication information can indicate whether the flexible slot is used for uplink transmission, which can improve resource utilization. In addition, for an uplink slot, the first indication information can also explicitly indicate whether the uplink slot can be used for uplink transmission. On the other hand, the first indication information provided in the disclosure can be carried in a message for scheduling uplink transmission rather than be carried in other DCI, thereby avoiding loss of the information that will result in inconsistent understanding between the network device and the terminal device regarding a slot used for uplink transmission.

Implementation II will be described below.

Optionally, with regard to uplink repetitions of the target PUCCH, the first indication information may be carried in second DCI for scheduling a physical downlink shared channel (PDSCH). This is because the target PUCCH carries feedback information of the PDSCH.

Optionally, the second DCI may contain the number of repetitions for the target PUCCH. The number of repetitions may be the number K1 of nominal repetitions or the number K2 of actual repetitions, where K1 and K2 each are an integer, K1>1, and K2>1. The number K1 of nominal repetitions refers to the number of repetitions for the target PUCCH configured for the terminal device by the network device, but the number of actual repetitions of the terminal device may be less than or equal to the number of nominal repetitions. The number K2 of actual repetitions refers to the number of actual repetitions of the terminal device for the target PUCCH.

It should be understood that, if the second DCI contains the number K1 of nominal repetitions for the target PUCCH, the K1 repetitions for the uplink repetitions correspond to K1 consecutive slots, where the K1 consecutive slots constitute a first slot set, and the at least one target slot is a slot in the first slot set. It should be noted that, the first slot set may also be any slot set configured for the terminal device by the network device. There is no limitation on how to determine the first slot set in the disclosure.

It should be understood that, if the second DCI contains the number K2 of actual repetitions for the target PUCCH, the terminal device can search for K2 available slots according to a start position for repetitions configured for the terminal device by the network device and the number K2 of actual repetitions.

It should be understood that, in order to distinguish the available slot in different implementations described above, in implementation II, the available slot may also be referred to as a first slot.

It should be noted that, in implementation II, regarding how to determine the length of the first indication information, reference can be made to the scheme for determining the length of the first indication information in implementation I, which will not be described in detail again in the disclosure.

Implementation III will be described below.

For the case where the uplink transmission of the target channel is the uplink repetitions of the initial transmission carrying Msg3, the first indication information may be carried in Msg2, but is not limited thereto.

Optionally, the Msg2 may contain the number of repetitions for the uplink repetitions. The number of repetitions may be the number K1 of nominal repetitions or the number K2 of actual repetitions, where K1 and K2 each are an integer, K1>1, and K2>1. The number K1 of nominal repetitions refers to the number of repetitions for the uplink repetitions of the initial transmission carrying Msg3 configured for the terminal device by the network device, but the number of actual repetitions of the terminal device may be less than or equal to the number of nominal repetitions. The number K2 of actual repetitions refers to the number of actual repetitions of the terminal device for the initial transmission carrying Msg3.

It should be noted that, if the Msg2 contains the number K1 of nominal repetitions for the uplink repetitions, the K1 repetitions for the uplink repetitions correspond to K1 consecutive slots, where the K1 consecutive slots constitute a first slot set, and the at least one target slot is a slot in the first slot set. It should be noted that, the first slot set may also be any slot set configured for the terminal device by the network device. There is no limitation on how to determine the first slot set in the disclosure.

It should be understood that, if the Msg2 contains the number K2 of actual repetitions for the uplink repetitions, the terminal device can search for K2 available slots according to a start position for repetitions configured for the terminal device by the network device and the number K2 of actual repetitions.

It should be understood that, in order to distinguish the available slot in different implementations described above, in implementation III, the available slot may also be referred to as a first slot.

It should be noted that, in implementation III, regarding how to determine the length of the first indication information, reference can be made to the scheme for determining the length of the first indication information in implementation I, which will not be described in detail again in the disclosure.

Implementation IV will be described below.

For the case where the uplink transmission of the target channel is the uplink repetitions of the retransmission carrying Msg3, the first indication information may be carried in third DCI (for example, DCI format 0_0 scrambled by a TC-RNTI) for scheduling the retransmission, but is not limited thereto.

Optionally, the third DCI may contain the number of repetitions for the uplink repetitions. The number of repetitions may be the number K1 of nominal repetitions or the number K2 of actual repetitions, where K1 and K2 each are an integer, K1>1, and K2>1. The number K1 of nominal repetitions refers to the number of repetitions for the uplink repetitions of the retransmission carrying Msg3 configured for the terminal device by the network device, but the number of actual repetitions of the terminal device may be less than or equal to the number of nominal repetitions. The number K1 of nominal repetitions refers to the number of actual repetitions of the terminal device for the retransmission carrying Msg3.

It should be noted that, if the third DCI contains the number K1 of nominal repetitions for the uplink repetitions, the K1 repetitions for the uplink repetitions correspond to K1 consecutive slots, where the K1 consecutive slots constitute a first slot set, and the at least one target slot is a slot in the first slot set. It should be noted that, the first slot set may also be any slot set configured for the terminal device by the network device. There is no limitation on how to determine the first slot set in the disclosure.

It should be understood that, if the third DCI contains the number K2 of actual repetitions for the uplink repetitions, the terminal device can search for K2 available slots according to a start position for repetitions configured for the terminal device by the network device and the number K2 of actual repetitions.

It should be understood that, in order to distinguish the available slot in different implementations described above, in implementation IV, the available slot may also be referred to as a first slot.

It should be noted that, in the implementation IV, regarding how to determine the length of the first indication information, reference can be made to the scheme for determining the length of the first indication information in implementation I, which will not be described in detail again in the disclosure.

Implementation V will be described below.

Optionally, for the case where the uplink transmission is a multi-slot transmission of a TB, the first indication information may be carried in fourth DCI for scheduling the multi-slot transmission.

Optionally, the fourth DCI may contain the number of slots used for multi-slot transmission in the multi-slot transmission. The number of slots may be a nominal number K3 of slots or an actual number K4 of slots, where K3 and K4 each are an integer, K3>1, and K4>1. The nominal number K3 of slots refers to the number of slots for multi-slot transmission configured for the terminal device by the network device, but the number of slots actually used for multi-slot transmission of the terminal device may be less than or equal to the nominal number of slots. The actual number K4 of slots refers to the actual number of slots of the terminal device for the multi-slot transmission.

It should be understood that, if the fourth DCI contains the number K3 of slots nominally used for multi-slot transmission in the multi-slot transmission, the multi-slot transmission corresponds to K3 consecutive slots, where the K3 consecutive slots constitute a second slot set, and the at least one target slot is a slot in the second slot set. It should be noted that, the second slot set may also be any slot set configured for the terminal device by the network device. There is no limitation on how to determine the second slot set in the disclosure.

It should be understood that, if the fourth DCI contains the number K4 of slots actually used for multi-slot transmission in the multi-slot transmission, the terminal device can search for K4 available slots according to a start position for multi-slot transmission configured for the terminal device by the network device and the number K4 of slots actually used for multi-slot transmission.

It should be understood that, in order to distinguish the available slot in different implementations described above, in the implementation V, the available slot may be referred to as a second slot.

Optionally, assuming that the at least one target slot is all flexible slot(s), the length of the first indication information or the number of bits occupied by the first indication information may be any one of the following, but is not limited thereto.

(1) The first indication information has a length of one bit.

It should be understood that, if the at least one target slot is one flexible slot, the first indication information indicates whether the flexible slot is used for the multi-slot transmission. If the at least one target slot is multiple flexible slots, the first indication information jointly indicates (namely, simultaneously indicates) whether the flexible slots are used for the multi-slot transmission.

Optionally, for a flexible slot, the network device may determine, based on a symbol corresponding to the multi-slot transmission in the flexible slot, whether the flexible slot is used for the multi-slot transmission. If the network device determines that the symbol corresponding to the multi-slot transmission in the flexible slot is not a downlink symbol, the network device can determine that the flexible slot can be used for the multi-slot transmission. Otherwise, if the network device determines that the symbol corresponding to the multi-slot transmission in the flexible slot is a downlink symbol, the network device can determine that the flexible slot cannot be used for the multi-slot transmission.

It should be understood that, in the disclosure, there is no limitation on how the network device determines whether the flexible slot is used for the multi-slot transmission.

Optionally, assume that at least one target slot is multiple flexible slots. When the first indication information jointly indicates whether the flexible slots are used for the multi-slot transmission, if at least one of the flexible slots cannot be used for the multi-slot transmission, the network device will indicate, via the first indication information, that the flexible slots cannot be used for the multi-slot transmission; otherwise, if all of the flexible slots can be used for the multi-slot transmission, the network device will indicate, via the first indication information, that the flexible slots can be used for the multi-slot transmission.

(2) The first indication information has a length of N1 bits, where the N1 bits are in one-to-one correspondence with the at least one target slot, N1 is an integer and N1>1, and each of the N1 bits is indicative of whether a corresponding target slot is used for the multi-slot transmission.

N1 is the number of the at least one target slot.

It should be understood that, if the at least one target slot is one flexible slot, the first indication information indicates whether the flexible slot is used for the multi-slot transmission. If the at least one target slot is multiple flexible slots, each bit in the first indication information indicates whether a corresponding target slot is used for the multi-slot transmission.

Optionally, for a flexible slot, the network device may determine, based on a symbol corresponding to the multi-slot transmission in the flexible slot, whether the flexible slot is used for the multi-slot transmission. If the network device determines that the symbol corresponding to the multi-slot transmission in the flexible slot is not a downlink symbol, the network device can determine that the flexible slot can be used for the multi-slot transmission. Otherwise, if the network device determines that the symbol corresponding to the multi-slot transmission in the flexible slot is a downlink symbol, the network device can determine that the flexible slot cannot be used for the multi-slot transmission.

It should be understood that, in the disclosure, there is no limitation on how the network device determines whether the flexible slot is used for the multi-slot transmission.

(3) The first indication information has a length of K3 bits, where the K3 bits are in one-to-one correspondence with K3 consecutive slots, and each of the K3 bits is indicative of whether a corresponding slot in the K3 consecutive slots is used for the multi-slot transmission.

K3 is the number of slots in the second slot set, where the second slot set may have at least one of an uplink slot or a flexible slot. Each bit in the first indication information is indicative of whether a corresponding slot in the consecutive slots is used for the multi-slot transmission. Here, the consecutive slots each may be an uplink slot or a flexible slot. It can be understood that, if the at least one target slot is all flexible slot(s) (in this case, the uplink slot is understood as available for the multi-slot transmission), for any uplink slot in the K3 consecutive slots, the terminal device will not determine, according to the first indication information, whether the uplink slot is used for the multi-slot transmission; and for any flexible slot in the K3 consecutive slots, the terminal device needs to determine, according to the first indication information, whether the flexible slot is used for the multi-slot transmission.

Optionally, for a flexible slot, the network device may determine, based on a symbol corresponding to the multi-slot transmission in the flexible slot, whether the flexible slot is used for the multi-slot transmission. If the network device determines that the symbol corresponding to the multi-slot transmission in the flexible slot is not a downlink symbol, the network device can determine that the flexible slot can be used for the multi-slot transmission. Otherwise, if the network device determines that the symbol corresponding to the multi-slot transmission in the flexible slot is a downlink symbol, the network device can determine that the flexible slot cannot be used for the multi-slot transmission.

It should be understood that, in the disclosure, there is no limitation on how the network device determines whether the flexible slot is used for the multi-slot transmission.

Optionally, it is assumed that the at least one target slot is all uplink slot(s) (in this case, the uplink slot is understood as not yet determined regarding whether the uplink slot can be used for the multi-slot transmission), the length of the first indication information or the number of bits occupied by the first indication information may be any one of the following, but is not limited thereto.

(1) The first indication information has a length of one bit.

It should be understood that, if the at least one target slot is one uplink slot, the first indication information indicates whether the uplink slot is used for the multi-slot transmission. If the at least one target slot is multiple uplink slots, the first indication information jointly indicates (namely, simultaneously indicates) whether the uplink slots are used for the multi-slot transmission.

It should be understood that, in the disclosure, there is no limitation on how the network device determines whether the uplink slot is used for the multi-slot transmission.

Optionally, assume that the at least one target slot is multiple uplink slots. When the first indication information jointly indicates whether the uplink slots are used for the multi-slot transmission, if at least one of the uplink slots cannot be used for the multi-slot transmission, the network device will indicate, via the first indication information, that the uplink slots cannot be used for the multi-slot transmission; otherwise, if all of the uplink slots can be used for the multi-slot transmission, the network device will indicate, via the first indication information, that the uplink slots can be used for the multi-slot transmission.

(2) The first indication information has a length of N1 bits, where the N1 bits are in one-to-one correspondence with the at least one target slot, N1 is an integer and N1>1, and each of the N1 bits is indicative of whether a corresponding target slot is used for the multi-slot transmission.

N1 is the number of the at least one target slot.

It should be understood that, if the at least one target slot is one uplink slot, the first indication information indicates whether the uplink slot is used for the multi-slot transmission. If the at least one target slot is multiple uplink slots, each bit in the first indication information indicates whether a corresponding uplink slot is used for the multi-slot transmission.

It should be understood that, in the disclosure, there is no limitation on how the network device determines whether the uplink slot is used for the multi-slot transmission.

(3) The first indication information has a length of K3 bits, where the K3 bits are in one-to-one correspondence with K3 consecutive slots, and each of the K3 bits is used for indicating whether a corresponding slot in the K3 consecutive slots is used for the multi-slot transmission.

K3 is the number of slots in the second slot set.

Optionally, if the at least one target slot includes an uplink slot and a flexible slot (in this case, the uplink slot is understood as not yet determined regarding whether the uplink slot can be used for the multi-slot transmission), the length of the first indication information or the number of bits occupied by the first indication information may be any one of the following, but is not limited thereto.

(1) The first indication information has a length of one bit.

It should be understood that, if the at least one target slot is one uplink slot or one flexible slot, the first indication information indicates whether the uplink slot or the flexible slot is used for the multi-slot transmission. If the at least one target slot includes an uplink slot and a flexible slot, the first indication information jointly indicates (namely, simultaneously indicates) whether the slots are used for the multi-slot transmission.

It should be understood that, regarding how the network device determines whether the flexible slot is used for the multi-slot transmission, reference can be made to the above elaborations, which will not be described in detail again in the disclosure. In addition, in the disclosure, there is no limitation on how the network device determines whether the uplink slot is used for the multi-slot transmission.

(2) The first indication information has a length of two bits, where one of the two bits is indicative of whether an uplink slot in the at least one target slot is used for the multi-slot transmission, and the other one of the two bits is indicative of whether a flexible slot in the at least one target slot is used for the multi-slot transmission.

It should be understood that, regarding how the network device determines whether the flexible slot is used for the multi-slot transmission, reference can be made to the above elaborations, which will not be described in detail again in the disclosure. In addition, in the disclosure, there is no limitation on how the network device determines whether the uplink slot is used for the multi-slot transmission.

(3) The first indication information has a length of N1 bits, where the N1 bits are in one-to-one correspondence with the at least one target slot, N1 is an integer and N1>1, and each of the N1 bits is indicative of whether a corresponding target slot is used for the multi-slot transmission.

N1 is the number of the at least one target slot.

(4) The first indication information has a length of K3 bits, where the K3 bits are in one-to-one correspondence with K3 consecutive slots, and each of the K3 bits is indicative of whether a corresponding slot in the K3 consecutive slots is used for the multi-slot transmission.

K3 is the number of slots in the second slot set.

As can be seen, on one hand, for a flexible slot, the first indication information can indicate whether the flexible slot is used for uplink transmission, which can improve resource utilization. In addition, for an uplink slot, the first indication information can also explicitly indicate whether the uplink slot can be used for uplink transmission. On the other hand, the first indication information provided in the disclosure can be carried in a message for scheduling uplink transmission rather than be carried in other DCI, thereby avoiding loss of the information that will result in inconsistent understanding between the network device and the terminal device regarding a slot used for uplink transmission.

It should be noted that, if the message for scheduling uplink transmission does not carry the first indication information, the terminal device can determine, according to a slot format indicated by higher-layer signaling TDD-UL-DL-ConfigurationCommon or TDD-UL-DL-ConfigDedicated as well as a slot format determined based on other DCI, whether a flexible slot in a slot set is used for uplink transmission.

FIG. 9 is an interaction flowchart of another wireless communication method provided in embodiments of the disclosure. As illustrated in FIG. 9, the method includes the following.

S910, a network device sends first indication information to a terminal device, where the first indication information is indicative of whether at least one target slot is used for joint channel estimation for uplink transmission.

S920, the terminal device performs uplink transmission according to the first indication information.

It should be noted that, joint channel estimation may be joint channel estimation for a PUSCH, or may be joint channel estimation for a PUCCH, or may be joint channel estimation for multi-slot transmission of a TB, and the disclosure is not limited in this regard.

It should be understood that, in joint channel estimation of the network device, the network device will assume that a DMRS over multiple slots is relevant. Therefore, in the disclosure, joint channel estimation may be described as DMRS bundling, etc., and the disclosure is not limited in this regard.

It should be noted that, for elaborations of the first indication information and the uplink transmission, reference can be made to the embodiments corresponding to FIG. 7, which will not be elaborated again in the disclosure.

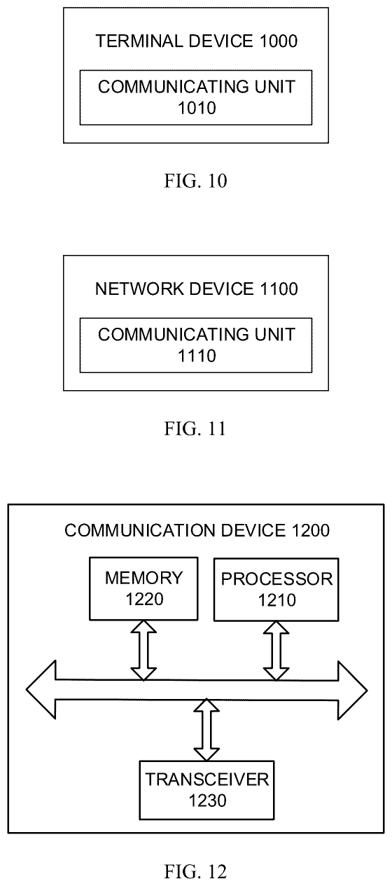

FIG. 10 is a schematic block diagram of a terminal device 1000 according to embodiments of the disclosure. The terminal device includes a communicating unit 1010. The communicating unit 1010 is configured to receive first indication information, where the first indication information is indicative of whether at least one target slot is used for uplink transmission of a target channel or is indicative of whether the at least one target slot is used for joint channel estimation for the uplink transmission. The communicating unit 1010 is configured to perform uplink transmission according to the first indication information.

Optionally, the uplink transmission is uplink repetitions, and the first indication information is carried in the first message.

Optionally, the target channel is a target PUSCH, and the first message is first DCI for scheduling the uplink repetitions.

Optionally, the target channel is a target PUCCH, and the first message is second DCI for scheduling a PDSCH.

Optionally, the uplink repetitions are uplink repetitions of an initial transmission carrying Msg3.

Optionally, the first message is Msg2.

Optionally, the uplink repetitions are uplink repetitions of a retransmission carrying Msg3.

Optionally, the first message is third DCI for scheduling the retransmission.

Optionally, the at least one target slot is a slot in a first slot set.

Optionally, the first message further contains the number K1 of nominal repetitions for the uplink repetitions, where K1 is an integer and K1>1, the K1 repetitions for the uplink repetitions correspond to K1 consecutive slots, and the K1 consecutive slots constitute the first slot set.

Optionally, the first message further contains the number K2 of actual repetitions for the uplink repetitions, where K2 is an integer and K2>1. The K2 repetitions correspond to K2 first slots. If the first indication information is indicative of whether the at least one target slot is used for the uplink transmission of the target channel, each first slot is an uplink slot or is the target slot used for the uplink repetitions indicated by the first indication information. If the first indication information is indicative of whether the at least one target slot is used for joint channel estimation for the uplink transmission, each first slot is an uplink slot or is the target slot used for joint channel estimation indicated by the first indication information.

Optionally, the uplink transmission is a multi-slot transmission of a TB.

Optionally, the first indication information is carried in fourth DCI for scheduling the multi-slot transmission.

Optionally, the at least one target slot is a slot in a second slot set.

Optionally, the fourth DCI further contains the number K3 of slots nominally used for multi-slot transmission in the multi-slot transmission, where K3 is an integer and K3>1, the multi-slot transmission corresponds to K3 consecutive slots, and the K3 consecutive slots constitute the second slot set.

Optionally, the fourth DCI further contains the number K4 of slots actually used for multi-slot transmission in the multi-slot transmission, where K4 is an integer and K4>1. The multi-slot transmission corresponds to K4 second slots. If the first indication information is indicative of whether the at least one target slot is used for the uplink transmission of the target channel, each second slot is an uplink slot or is the target slot used for the multi-slot transmission indicated by the first indication information. If the first indication information is indicative of whether the at least one target slot is used for joint channel estimation for the uplink transmission, each second slot is an uplink slot or is the target slot used for joint channel estimation indicated by the first indication information.

Optionally, the first indication information has a length of one bit.

Optionally, the first indication information has a length of N1 bits, where the N1 bits are in one-to-one correspondence with the at least one target slot, and N1 is an integer and N1>1. If the first indication information is indicative of whether the at least one target slot is used for the uplink transmission of the target channel, each of the N1 bits is indicative of whether a corresponding target slot is used for the uplink transmission. If the first indication information is indicative whether the at least one target slot is used for of joint channel estimation for the uplink transmission, each of the N1 bits is indicative of whether a corresponding target slot is used for joint channel estimation.

Optionally, the first indication information has a length of K1 bits, where the K1 bits are in one-to-one correspondence with the K1 consecutive slots. If the first indication information is indicative of whether the at least one target slot is used for the uplink transmission of the target channel, each of the K1 bits is indicative of whether a corresponding slot in the K1 consecutive slots is used for the uplink transmission. If the first indication information is indicative of whether the at least one target slot is used for joint channel estimation for the uplink transmission, each of the K1 bits is indicative of whether a corresponding slot in the K1 consecutive slots is used for joint channel estimation.

Optionally, for any uplink slot in the K1 consecutive slots, the terminal device does not determine whether the uplink slot is used for the uplink transmission according to the first indication information, or the terminal device does not determine whether the uplink slot is used for joint channel estimation according to the first indication information.

Optionally, the first indication information has a length of K3 bits, where the K3 bits are in one-to-one correspondence with the K3 consecutive slots. If the first indication information is indicative of whether the at least one target slot is used for the uplink transmission of the target channel, each of the K3 bits is indicative of whether a corresponding slot in the K3 consecutive slots is used for the uplink transmission. If the first indication information is indicative of whether the at least one target slot is used for joint channel estimation for the uplink transmission, each of the K3 bits is indicative of whether a corresponding slot in the K3 consecutive slots is used for joint channel estimation.

Optionally, for any uplink slot in the K3 consecutive slots, the terminal device does not determine whether the uplink slot is used for the uplink transmission according to the first indication information, or the terminal device does not determine whether the uplink slot is used for joint channel estimation according to the first indication information.

Optionally, each target slot is a flexible slot or an uplink slot.

Optionally, in some embodiments, the communicating unit may be a communication interface or a transceiver, or may be an input/output interface of a communication chip or a system-on-chip (SOC). The processing unit may be one or more processors.

It should be understood that, the terminal device 1000 according to embodiments of the disclosure may correspond to the terminal device in the method embodiments of the disclosure, and the foregoing and other operations and/or functions of various units in the terminal device 1000 are respectively intended for implementing corresponding operations of the terminal device in the methods illustrated in FIG. 7 and FIG. 9, which will not be described again herein for the sake of brevity.

FIG. 11 is a schematic block diagram of a network device 1100 according to embodiments of the disclosure. The network device includes a communicating unit 1110. The communicating unit 1110 is configured to send first indication information, where the first indication information is indicative of whether at least one target slot is used for uplink transmission of a target channel or is indicative of whether the at least one target slot is used for joint channel estimation for the uplink transmission.

Optionally, the uplink transmission is uplink repetitions, and the first indication information is carried in the first message.

Optionally, the target channel is a target PUSCH, and the first message is first DCI for scheduling the uplink repetitions.

Optionally, the target channel is a target PUCCH, and the first message is second DCI for scheduling a PDSCH.

Optionally, the uplink repetitions are uplink repetitions of an initial transmission carrying Msg3.

Optionally, the first message is Msg2.

Optionally, the uplink repetitions are uplink repetitions of a retransmission carrying Msg3.

Optionally, the first message is third DCI for scheduling the retransmission.

Optionally, the at least one target slot is a slot in a first slot set.

Optionally, the first message further contains the number K1 of nominal repetitions for the uplink repetitions, where K1 is an integer and K1>1, the K1 repetitions for the uplink repetitions correspond to K1 consecutive slots, and the K1 consecutive slots constitute the first slot set.

Optionally, the first message further contains the number K2 of actual repetitions for the uplink repetitions, where K2 is an integer and K2>1. The K2 repetitions correspond to K2 first slots. If the first indication information is indicative of whether the at least one target slot is used for the uplink transmission of the target channel, each first slot is an uplink slot or is the target slot used for the uplink repetitions indicated by the first indication information. If the first indication information is indicative of whether the at least one target slot is used for joint channel estimation for the uplink transmission, each first slot is an uplink slot or is the target slot used for joint channel estimation indicated by the first indication information.

Optionally, the uplink transmission is a multi-slot transmission of a TB.

Optionally, the first indication information is carried in fourth DCI for scheduling the multi-slot transmission.

Optionally, the at least one target slot is a slot in a second slot set.

Optionally, the fourth DCI further contains the number K3 of slots nominally used for multi-slot transmission in the multi-slot transmission, where K3 is an integer and K3>1, the multi-slot transmission corresponds to K3 consecutive slots, and the K3 consecutive slots constitute the second slot set.

Optionally, the fourth DCI further contains the number K4 of slots actually used for multi-slot transmission in the multi-slot transmission, where K4 is an integer and K4>1. The multi-slot transmission corresponds to K4 second slots. If the first indication information is indicative of whether the at least one target slot is used for the uplink transmission of the target channel, each second slot is an uplink slot or is the target slot used for the multi-slot transmission indicated by the first indication information. If the first indication information is indicative of whether the at least one target slot is used for joint channel estimation for the uplink transmission, each second slot is an uplink slot or is the target slot used for joint channel estimation indicated by the first indication information.

Optionally, the first indication information has a length of one bit.

Optionally, the first indication information has a length of N1 bits, where the N1 bits are in one-to-one correspondence with the at least one target slot, and N1 is an integer and N1>1. If the first indication information is indicative of whether the at least one target slot is used for the uplink transmission of the target channel, each of the N1 bits is indicative of whether a corresponding target slot is used for the uplink transmission. If the first indication information is indicative of whether the at least one target slot is used for joint channel estimation for the uplink transmission, each of the N1 bits is indicative of whether a corresponding target slot is used for joint channel estimation.

Optionally, the first indication information has a length of K1 bits, where the K1 bits are in one-to-one correspondence with the K1 consecutive slots. If the first indication information is indicative of whether the at least one target slot is used for the uplink transmission of the target channel, each of the K1 bits is indicative of whether a corresponding slot in the K1 consecutive slots is used for the uplink transmission. If the first indication information is indicative of whether the at least one target slot is used for joint channel estimation for the uplink transmission, each of the K1 bits is indicative of whether a corresponding slot in the K1 consecutive slots is used for joint channel estimation.

Optionally, the first indication information has a length of K3 bits, where the K3 bits are in one-to-one correspondence with the K3 consecutive slots. If the first indication information is indicative of whether the at least one target slot is used for the uplink transmission of the target channel, each of the K3 bits is indicative of whether a corresponding slot in the K3 consecutive slots is used for the uplink transmission. If the first indication information is indicative of whether the at least one target slot is used for joint channel estimation for the uplink transmission, each of the K3 bits is indicative of whether a corresponding slot in the K3 consecutive slots is used for joint channel estimation.

Optionally, each target slot is a flexible slot or an uplink slot.

Optionally, in some embodiments, the communicating unit may be a communication interface or a transceiver, or may be an input/output interface of a communication chip or an SOC.

It should be understood that, the network device 1100 according to embodiments of the disclosure may correspond to the network device in the method embodiments of the disclosure, and the foregoing and other operations and/or functions of various units in the network device 1100 are respectively intended for implementing corresponding operations of the network device in the methods illustrated in FIG. 7 and FIG. 9, which will not be described again herein for the sake of brevity.

FIG. 12 is a schematic structural diagram of a communication device 1200 provided in embodiment of the disclosure. The communication device 1200 illustrated in FIG. 12 includes a processor 1210. The processor 1210 can invoke and execute computer programs stored in a memory, to implement the method in embodiments of the disclosure.

Optionally, as illustrated in FIG. 12, the communication device 1200 may further include a memory 1220, where the processor 1210 can invoke and execute computer programs stored in the memory 1220 to implement the method in embodiments of the disclosure.

The memory 1220 may be a separate device independent of the processor 1210, or may be integrated into the processor 1210.

Optionally, as illustrated in FIG. 12, the communication device 1200 may further include a transceiver 1230. The processor 1210 can control the transceiver 1230 to communicate with other devices, and specifically, to send information or data to other devices or receive information or data sent by other devices.

The transceiver 1230 may include a transmitter and a receiver. The transceiver 1230 can further include an antenna, where one or more antennas may be provided.

Optionally, the communication device 1200 may specifically be a network device in embodiments of the disclosure, and the communication device 1200 may implement corresponding operations implemented by the network device in various methods in embodiments of the disclosure, which will not be described again herein for the sake of brevity.

Optionally, the communication device 1200 may specifically be a terminal device in embodiments of the disclosure, and the communication device 1200 may implement corresponding operations implemented by the terminal device in various methods in embodiments of the disclosure, which will not be described again herein for the sake of brevity.

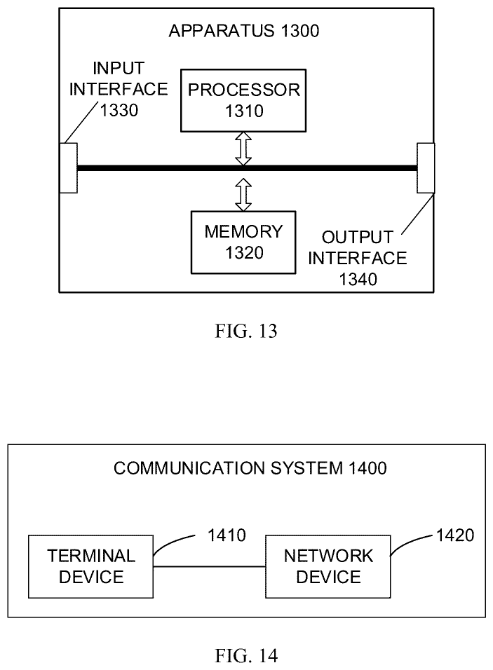

FIG. 13 is a schematic structural diagram of an apparatus according to embodiments of the disclosure. The apparatus 1300 illustrated in FIG. 13 includes a processor 1310. The processor 1310 can invoke and execute computer programs stored in a memory, so as to implement the method in embodiments of the disclosure.

Optionally, as illustrated in FIG. 13, the apparatus 1300 may further include a memory 1320. The processor 1310 can invoke and execute computer programs stored in the memory 1320, so as to implement the method in embodiments of the disclosure.

The memory 1320 may be a separate device independent of the processor 1310, or may be integrated into the processor 1310.

Optionally, the apparatus 1300 may further include an input interface 1330. The processor 1310 can control the input interface 1330 to communicate with other devices or chips, and specifically, to obtain information or data sent by other devices or chips.

Optionally, the apparatus 1300 may further include an output interface 1340. The processor 1310 can control the output interface 1340 to communicate with other devices or chips, and specifically, to output information or data to other devices or chips.

Optionally, the apparatus may be applied to the network device in embodiments of the disclosure, and the apparatus may implement corresponding operations implemented by the network device in various methods in embodiments of the disclosure, which will not be described again herein for the sake of brevity.

Optionally, the apparatus may be applied to the terminal device in embodiments of the disclosure, and the apparatus may implement corresponding operations implemented by the terminal device in various methods in embodiments of the disclosure, which will not be described again herein for the sake of brevity.

Optionally, the apparatus in embodiments of the disclosure may also be a chip, for example, an SOC.

FIG. 14 is a schematic block diagram of a communication system 1400 provided in embodiments of the disclosure. As illustrated in FIG. 14, the communication system 1400 includes a terminal device 1410 and a network device 1420.

The terminal device 1410 may be configured to implement corresponding functions implemented by the terminal device in the foregoing methods, and the network device 1420 may be configured to implement corresponding functions implemented by the network device or a base station in the foregoing methods, which will not be described again herein for the sake of brevity.

It should be understood that, the processor in embodiments of the disclosure may be an integrated circuit chip with signal processing capabilities. During embodiment, each step of the foregoing method embodiments may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in embodiments of the disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory of the systems and methods described in the disclosure is intended to include, but is not limited to, these and any other suitable types of memory.

It should be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, etc. In other words, the memory in embodiments of the disclosure is intended to include, but is not limited to, these and any other suitable types of memory.

Embodiments of the disclosure further provide a computer-readable storage medium. The computer-readable storage medium is configured to store computer programs.

Optionally, the computer-readable storage medium may be applied to the network device or a base station in embodiments of the disclosure, and the computer programs are operable with a computer to execute corresponding operations implemented by the network device or the base station in various methods in embodiments of the disclosure, which will not be described again herein for the sake of brevity.

Optionally, the computer-readable storage medium may be applied to a mobile terminal/terminal device in embodiments of the disclosure, and the computer programs are operable with a computer to execute corresponding operations implemented by the mobile terminal/terminal device in various methods in embodiments of the disclosure, which will not be described again herein for the sake of brevity.

Embodiments of the disclosure further provide a computer program product. The computer program product includes computer program instructions.

Optionally, the computer program product may be applied to the network device or a base station in embodiments of the disclosure, and the computer program instructions are operable with a computer to execute corresponding operations implemented by the network device or the base station in various methods in embodiments of the disclosure, which will not be described again herein for the sake of brevity.

Optionally, the computer program product may be applied to a mobile terminal/terminal device in embodiments of the disclosure, and the computer program instructions are operable with a computer to execute corresponding operations implemented by the mobile terminal/terminal device in various methods in embodiments of the disclosure, which will not be described again herein for the sake of brevity.

Embodiments of the disclosure further provide a computer program.

Optionally, the computer program may be applied to the network device or a base station in embodiments of the disclosure. The computer program, when executed by a computer, is operable to implement corresponding operations implemented by the network device or the base station in various methods in embodiments of the disclosure, which will not be described again herein for the sake of brevity.

Optionally, the computer program may be applied to a mobile terminal/terminal device in embodiments of the disclosure. The computer program, when executed by a computer, is operable to implement corresponding operations implemented by the mobile terminal/terminal device in various methods in embodiments of the disclosure, which will not be described again herein for the sake of brevity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, a ROM, a RAM, a magnetic disk, or an optical disk.

The foregoing elaborations are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A wireless communication method, comprising:
receiving, by a terminal device, first indication information, wherein the first indication information is indicative of whether at least one target slot is used for uplink transmission of a target channel or is indicative of whether the at least one target slot is used for joint channel estimation for the uplink transmission; and
performing, by the terminal device, the uplink transmission according to the first indication information.

2. The method of claim 1, wherein the uplink transmission is uplink repetitions, and the first indication information is carried in a first message.

3. The method of claim 2, wherein one of:
the target channel is a target physical uplink shared channel (PUSCH); and the first message is first downlink control information (DCI) for scheduling the uplink repetitions; or
the target channel is a target physical uplink control channel (PUCCH), and the first message is second DCI for scheduling a physical downlink shared channel (PDSCH).

4. The method of claim 2, wherein the uplink repetitions are uplink repetitions of an initial transmission carrying message 3 (Msg3), and the first message is message 2 (Msg2).

5. The method of claim 2, wherein the uplink repetitions are uplink repetitions of a retransmission carrying Msg3, and the first message is third DCI for scheduling the retransmission.

6. The method of claim 1, wherein the uplink transmission is a multi-slot transmission of a transport block (TB), the first indication information is carried in fourth DCI for scheduling the multi-slot transmission, and the at least one target slot is a slot in a second slot set.

7. The method of claim 6, wherein the fourth DCI further contains a number K3 of slots nominally used for multi-slot transmission in the multi-slot transmission, wherein K3 is an integer and K3>1, the multi-slot transmission corresponds to K3 consecutive slots, and the K3 consecutive slots constitute the second slot set.

8. The method of claim 6, wherein the fourth DCI further contains a number K4 of slots actually used for multi-slot transmission in the multi-slot transmission, wherein K4 is an integer and K4>1, and wherein:
the multi-slot transmission corresponds to K4 second slots; when the first indication information is indicative of whether the at least one target slot is used for the uplink transmission of the target channel, each second slot is an uplink slot or is the target slot used for the multi-slot transmission indicated by the first indication information; and when the first indication information is indicative of whether the at least one target slot is used for joint channel estimation for the uplink transmission, each second slot is an uplink slot or is the target slot used for joint channel estimation indicated by the first indication information.

9. The method of claim 7, wherein the first indication information has a length of K3 bits, wherein the K3 bits are in one-to-one correspondence with the K3 consecutive slots, and wherein:
when the first indication information is indicative of whether the at least one target slot is used for the uplink transmission of the target channel, each of the K3 bits is indicative of whether a corresponding slot in the K3 consecutive slots is used for the uplink transmission; and when the first indication information is indicative of whether the at least one target slot is used for joint channel estimation for the uplink transmission, each of the K3 bits is indicative of whether a corresponding slot in the K3 consecutive slots is used for joint channel estimation.

10. The method of claim 9, wherein for any uplink slot in the K3 consecutive slots, the terminal device does not determine whether the uplink slot is used for the uplink transmission according to the first indication information, or the terminal device does not determine whether the uplink slot is used for joint channel estimation according to the first indication information.

11. The method of claim 1, wherein each target slot is a flexible slot or an uplink slot.

12. A wireless communication method, comprising:
sending, a network device, first indication information, wherein the first indication information is indicative of whether at least one target slot is used for uplink transmission of a target channel or is indicative of whether the at least one target slot is used for joint channel estimation for the uplink transmission.

13. The method of claim 12, wherein the uplink transmission is uplink repetitions, and the first indication information is carried in a first message.

14. The method of claim 13, wherein the at least one target slot is a slot in a first slot set, wherein the first message further contains a number K1 of nominal repetitions for the uplink repetition, wherein K1 is an integer and K1>1, the K1 repetitions for the uplink repetitions correspond to K1 consecutive slots, and the K1 consecutive slots constitute the first slot set.

15. The method of claim 13, wherein the first message further contains a number K2 of actual repetitions for the uplink repetitions, wherein K2 is an integer and K2>1, and wherein:
the K2 repetitions correspond to K2 first slots; when the first indication information is indicative of whether the at least one target slot is used for the uplink transmission of the target channel, each first slot is an uplink slot or is the target slot used for the uplink repetitions indicated by the first indication information; and when the first indication information is indicative of whether the at least one target slot is used for joint channel estimation for the uplink transmission, each first slot is an uplink slot or is the target slot used for joint channel estimation indicated by the first indication information.

16. The method of claim 12, wherein the first indication information has a length of one bit.

17. The method of claim 12, wherein the first indication information has a length of N1 bits, wherein the N1 bits are in one-to-one correspondence with the at least one target slot, and N1 is an integer and N1>1, and wherein:
when the first indication information is indicative of whether the at least one target slot is used for the uplink transmission of the target channel, each of the N1 bits is indicative of whether a corresponding target slot is used for the uplink transmission; and when the first indication information is indicative of whether the at least one target slot is used for joint channel estimation for the uplink transmission, each of the N1 bits is indicative of whether a corresponding target slot is used for joint channel estimation.

18. The method of claim 14, wherein the first indication information has a length of K1 bits, wherein the K1 bits are in one-to-one correspondence with the K1 consecutive slots, and wherein:
when the first indication information is indicative of whether the at least one target slot is used for the uplink transmission of the target channel, each of the K1 bits is indicative of whether a corresponding slot in the K1 consecutive slots is used for the uplink transmission; and when the first indication information is indicative of whether the at least one target slot is used for joint channel estimation for the uplink transmission, each of the K1 bits is indicative of whether a corresponding slot in the K1 consecutive slots is used for joint channel estimation.

19. A terminal device, comprising:
a transceiver;
a memory configured to store computer programs; and
a processor configured to invoke and execute the computer programs stored in the memory to:
cause the transceiver to receive first indication information, wherein the first indication information is indicative of whether at least one target slot is used for uplink transmission of a target channel or is indicative of whether the at least one target slot is used for joint channel estimation for the uplink transmission; and
perform the uplink transmission according to the first indication information.

20. A network device, comprising:
a transceiver;
a memory configured to store computer programs; and
a processor configured to invoke and execute the computer programs stored in the memory to:
cause the transceiver to send first indication information, wherein the first indication information is indicative of whether at least one target slot is used for uplink transmission of a target channel or is indicative of whether the at least one target slot is used for joint channel estimation for the uplink transmission.
